(19) United States
(12) Patent Application Publication
(10) Pub. No.: US 2006/0012532 A1
(43) Pub. Date: Jan. 19, 2006

(54) Antenna device for motor vehicle

(76) Inventors: Yuji Baba, Minato-ku (JP); Tatsumi Tokuda, Minato-ku (JP)

Correspondence Address: RATNERPRESTIA, P O BOX 980, VALLEY FORGE, PA, 19482-0980, US

(21) Appl. No.: 11/182,640

(22) Filed: Jul. 15, 2005

(30) Foreign Application Priority Data
Jul. 16, 2004 (JP) 2004-210359

(51) Int. Cl. H01Q 1/32

(52) U.S. Cl. 343/713; 343/704

(57) ABSTRACT

A glass antenna device having an AM and FM antennas provided on a rear window glass panel on which a defogger is formed is provided, the sensitivity and directivity of the device being improved. The device comprises a defogger provided on a rear window glass panel of the motor vehicle, an AM antenna provided in a space other than the defogger on the rear window glass panel, an FM antenna provided in a space between the defogger and the AM antenna on the rear window glass panel, a two-input amplifier for amplifying signals received by the AM and FM antennas, an AM lead wire for connecting between a feeding terminal of the AM antenna and the amplifier, an FM lead wire for connecting between a feeding terminal of the FM antenna and the amplifier, and an inductor inserted in the AM lead wire near to the AM feeding terminal.

### BACKGROUND OF THE INVENTION

1. Field of the Invention

The present invention relates to an antenna device comprising a glass antenna formed on a window glass panel of a motor vehicle, particularly to an antenna device comprising a glass antenna formed on a rear window glass panel on which a defogger is provided.

2. Related Art

In Japanese Patent Publication No. P2003-500870A, there is disclosed a glass antenna device for a motor vehicle comprising an AM antenna and an FM antenna on a rear window glass panel provided with a defogger for defogging. FIG. 1 shows the glass antenna device disclosed in the above-described publication.

In this glass antenna device, an AM antenna 12, an FM antenna 14, and a defogger 16 are formed on a rear window glass panel 10.

The AM antenna 12 is composed of an antenna pattern consisting of a plurality of linear conductors arranged in a horizontal direction like a fork shape. The sensitivity of the AM antenna 12 is determined by the area of an antenna pattern thereof, so that the AM antenna 12 is provided in such a manner that the antenna pattern occupies the most part of a space above the defogger 16 on the rear window glass panel 10.

The FM antenna 14 is formed by one linear conductor extending in a horizontal direction on a space between the antenna 12 and the defogger 16.

The defogger 16 comprises bus-bars 16a and 16b arranged oppositely in an up and down direction on both sides of the rear window glass panel 10, a plurality of heating lines 16c arranged in a horizontal direction between the bus-bars 16a and 16b, and a short-circuit line 16d to connect the plurality of heating lines. The bus-bars 16a and 16b are connected to a direct-current (DC) power supply 20 through choke coils 18a and 18b, respectively.

A feeding terminal 12a of the AM antenna 12 is connected through a lead wire 12b to a two-input amplifier 22, and a feeding terminal 14a of the FM antenna 14 is connected through a leas wire 14b to the amplifier 22. The amplifier 22 is connected to a radio set (not shown) through a coaxial cable 24.

When the AM and FM antennas 12 and 14 are provided in a space other than the defogger on the rear window glass panel 10 and the two-input amplifier 22 is used, the directivity of the FM antenna is remarkably degraded in a given angle. This is due to the fact that while the sensitivity of the FM antenna is tuned by the length of the FM antenna element including the lead wire, a capacitive coupling to heating lines of the defogger, and a capacitive coupling to the AM antenna, the directivity of the FM antenna is affected by the approaching of the AM antenna to a motor vehicle body.

### SUMMARY OF THE INVENTION

It is therefore an object of the present invention to improve the directivity of the FM antenna in a glass antenna device having the AM and FM antennas provided on a rear window glass panel on which a defogger is formed.

A first aspect of the present invention is an antenna device for a motor vehicle comprising a defogger provided on a rear window glass panel of the motor vehicle; an AM antenna provided in a space other than the defogger on the rear window glass panel; an FM antenna provided in a space between the defogger and the AM antenna on the rear window glass panel; a two-input amplifier for amplifying signals received by the AM and FM antennas; an AM lead wire for connecting between a feeding terminal of the AM antenna and the amplifier; an FM lead wire for connecting between a feeding terminal of the FM antenna and the amplifier; and an inductor inserted in the AM lead wire near to the AM feeding terminal; wherein the inductor opens the AM lead wire in a high frequency to cut off a signal from the AM antenna when a signal received by the FM antenna is amplified by the amplifier.

A second aspect of the present invention is an antenna device for a motor vehicle comprising a defogger provided on a rear window glass panel of the motor vehicle; an AM antenna provided in a space other the defogger on the rear window glass panel; an FM antenna provided in a space between the defogger and the AM antenna on the rear window glass panel; a two-input amplifier for amplifying signals received by the AM and FM antennas; a terminal base provided near to the feeding terminal of the AM antenna on the rear window glass panel; an inductor provided between the feeding terminal of the AM antenna and the terminal base; an AM lead wire for connecting between the terminal base and the amplifier; and; an FM lead wire for connecting between a feeding terminal of the FM antenna and the amplifier; wherein the inductor opens the AM lead wire in a high frequency to cut off a signal from the AM antenna when a signal received by the FM antenna is amplified by the amplifier.

A third aspect of the present invention is an antenna device for a motor vehicle comprising a defogger provided on a rear window glass panel of the motor vehicle; an AM antenna provided in a space other than the defogger on the rear window glass panel; an FM antenna provided in a space between the defogger and the AM antenna on the rear glass window panel; a two-input amplifier for amplifying signals received by the AM and FM antennas; a feeding terminal of the AM antenna provided with an inductor; an AM lead wire for connecting between a feeding terminal of the AM antenna and the amplifier; and an FM lead wire for connecting between a feeding terminal of the FM antenna and the amplifier; wherein the inductor opens the AM lead wire in a high frequency to cut off a signal from the AM antenna when a signal received by the FM antenna is amplified by the amplifier.

It is preferable in the glass antenna devices described above that the inductance of the inductor is in the range of 1.0 μH -6.8 μH.

According to the glass antenna device for a motor vehicle of the present invention, a good directivity of the FM antenna is obtained by inserting the inductor in the AM lead wire, because the inductor opens the AM lead wire in a high frequency to present the directivity of the FM antenna from being affected by the AM antenna. A good directivity of the FM antenna means herein that the sensitivity of the FM antenna is 15 dB or more, preferably 20 dB or more, more preferably 30 dB or more is held at the entire perimeter in an approximately horizontal direction.

### BRIEF DESCRIPTION OF THE DRAWINGS

FIG. 1 shows a conventional glass antenna device for a motor vehicle.

FIG. 2 shows a glass antenna device for a motor vehicle in accordance with the present invention.

FIGS. 3A-3U show the measured directivity for a glass antenna device having no inductor, respectively.

FIGS. 4A-4U show the measured directivity for a glass antenna device having an inductor of 0.68 H, respectively.

FIGS. 5A-5U show the measured directivity for a glass antenna device having an inductor of 1.0 μH, respectively.

FIGS. 6A-6U show the measured directivity for a glass antenna device having an inductor of 2.2 μH, respectively.

FIGS. 7A-7U show the measured directivity for a glass antenna device having an inductor of 3.9 μH, respectively.

FIGS. 8A-8U show the measured directivity for a glass antenna device having an inductor of 6.8 μH, respectively.

FIGS. 9A-9U show the measured directivity for a glass antenna device having an inductor of 8.2 μH, respectively.

FIG. 10 shows measured sensitivity for a glass antenna device having no inductor.

FIG. 11 shows measured sensitivity for a glass antenna device having an inductor of 0.68 μH

FIG. 12 shows measured sensitivity for a glass antenna device having an inductor of 1.0 μH

FIG. 13 shows measured sensitivity for a glass antenna device having an inductor of 2.2 μH

FIG. 14 shows measured sensitivity for a glass antenna device having an inductor of 3.9 μH

FIG. 15 shows measured sensitivity for a glass antenna device having an inductor of 6.8 μH

FIG. 16 shows measured sensitivity for a glass antenna device having an inductor of 8.2 μH

FIG. 17 shows an example of the mounting of an inductor.

FIG. 18 shows another example of the mounting of an inductor.

FIG. 19 shows a further example of the mounting of an inductor.

### BEST MODE FOR CARRYING OUT THE INVENTION

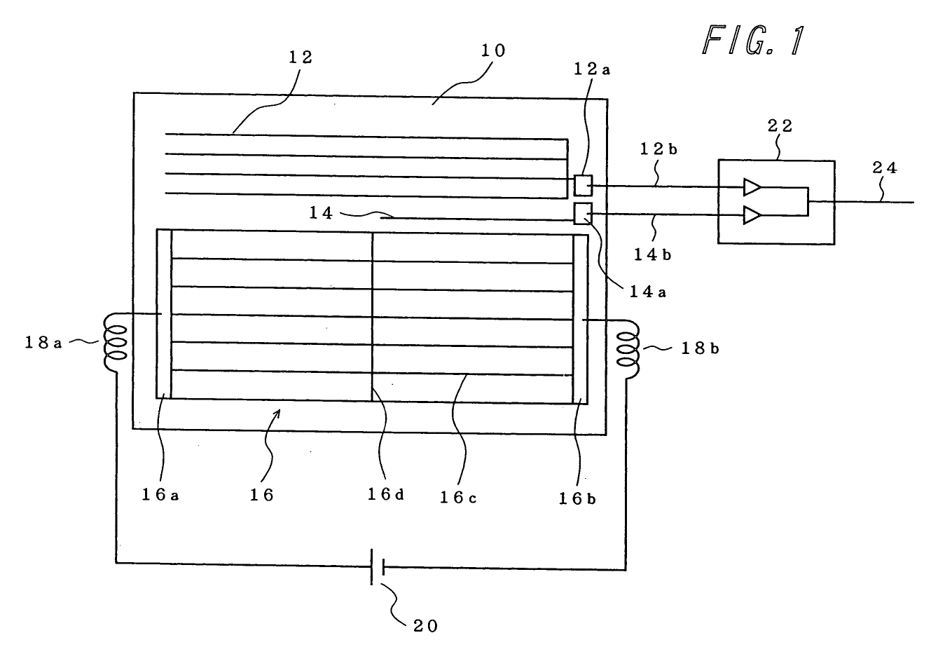

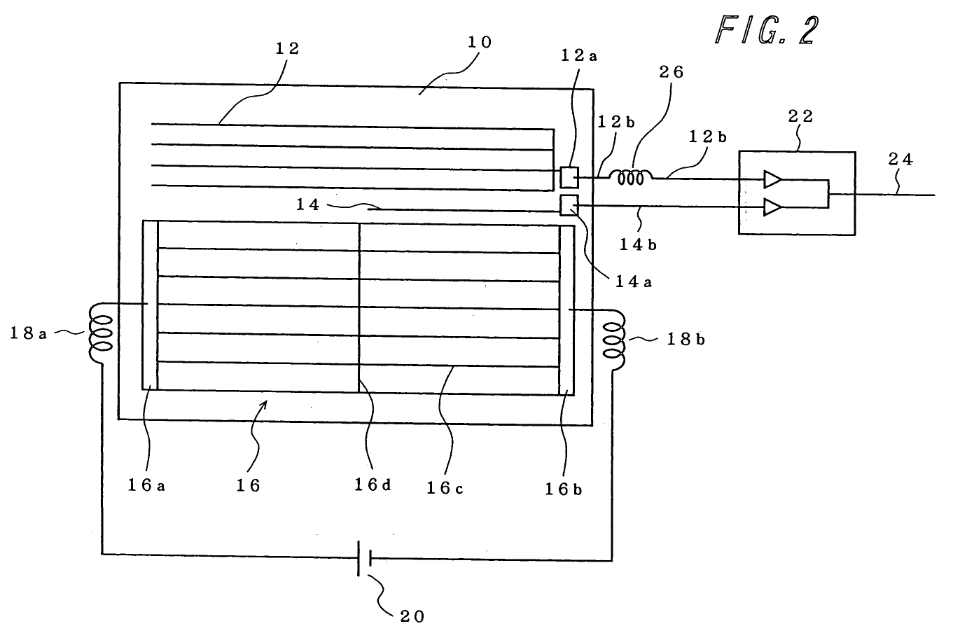

Reference to FIG. 2, there is shown a glass antenna device of an embodiment in accordance with the present invention. An inductor 26 is inserted in the lead wire 12b between the AM feeding terminal 12a and the two-input amplifier 22 in the glass antenna device shown in FIG. 1. The residual structure in FIG. 2 is the same as that in FIG. 1. Therefore, the same component in FIGS. 1 and 2 is designated by the same reference numeral.

The purpose of the inductor 26 is to open the AM lead wire 12b in a high frequency. If the AM lead wire 12b is opened in a high frequency, the high frequency received by the AM antenna may be cut off by the inductor to avoid an adverse effect to the directivity of the FM antenna 14.

It is preferable that the inductor 26 is provided at a position near to the feeding terminal 12a of the AM antenna 12. This is due to the fact that if a capacitive coupling is generated between the AM lead wire 12b (between the inductor 26 and the feeding terminal 12a) and the FM lead wire 14b arranged in proximity to each other, the high frequency received by the AM antenna 12 is connected to the FM lead wire 14b through the generated coupling capacitor prior to the high frequency is cut off by the inductor 26. Therefore, when the inductor 26 is provided in the two-input amplifier 22, the effect of the inductor may not be essentially obtained.

An AM bandwidth is in the range of 500 kHz-1.6 MHz, an FM bandwidth (in Japan) is in the range of 76 MHz-90 MHz, and an FM bandwidth (in foreign counties) is in the range of 88 MHz-108 MHz. In order to open the AM lead wire 12b in a high frequency, the inductor 26 is required to have a high impedance to the FM bandwidth.

The values of effective inductance of the inductor were measured. The fork-shaped AM antenna 12 was constructed by nine linear conductors each having approximately 100 cm arranged in parallel at 2 cm intervals and each one end thereof being connected together. The FM antenna 14 was structured by one linear conductor of approximately 27 cm length. The distance between the AM antenna 12 and the defogger 16 was approximately 3 cm, and the distance between the FM antenna 14 and the defogger 16 was approximately 0.5 cm.

The length of the AM lead wire 12b in which the inductor 26 was inserted was 24.5 cm, and the length of the FM lead wire 14b was 20 cm. The length of the AM lead wire 12b between the feeding terminal 12a and the inductor 26 was 4 cm. The structure of the AM lead wire 12b in which the inductor 26 is inserted will be described later with reference to FIG. 17.

The motor vehicle provided with the above-described antenna device was set in an electric wave dark room and rotated around 360° to measure the sensitivity and directivity for an FM wave coming from an approximately horizontal direction (the elevation angle was approximately 2°). The sensitivity and directivity was measured for each case of the inductance L of the inductor 26 such as 0.68 μH, 1.0 μH, 2.2 μH, 3.9 μH, 6.8 μH or 8.2 μH. For comparison, the sensitivity and directivity of the glass antenna device having no inductor was measured. It is noted that the sensitivity was designated by a dipole (=60 dB) ratio sensitivity (dB). The measuring was carried out in such a manner that the FM wave was varied in a unit of 1 MHz in the range of 88 MHz-108 MHz.

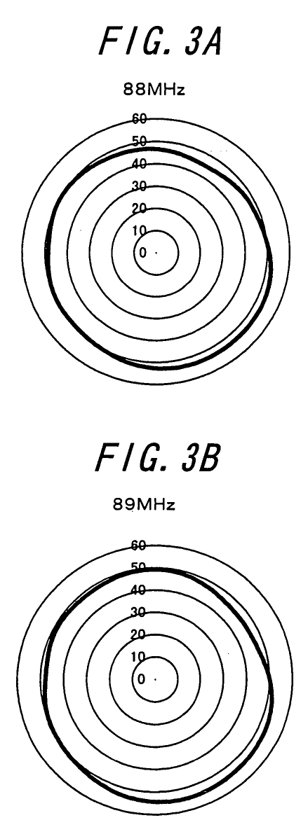

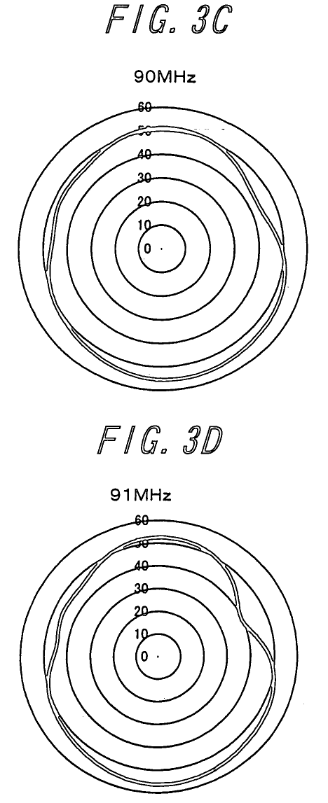

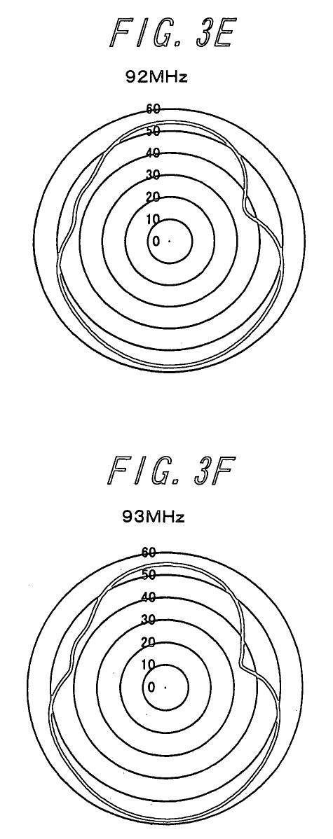

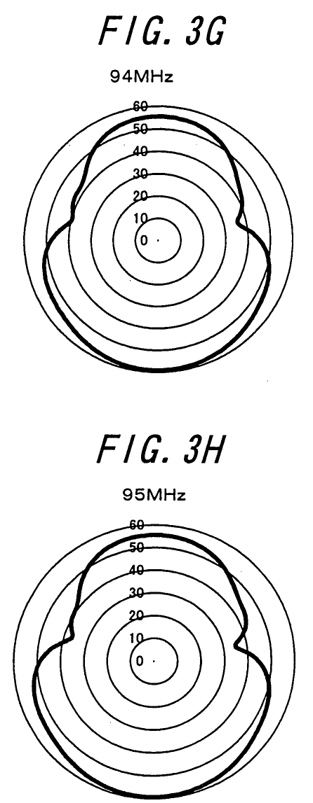

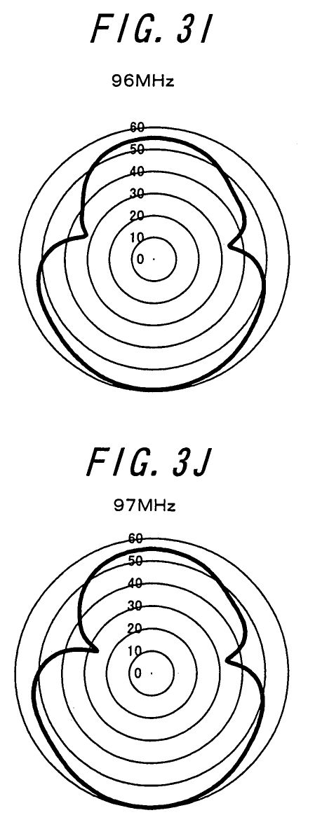

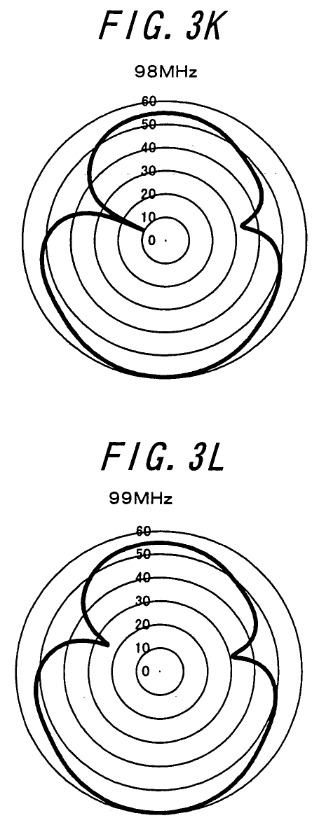

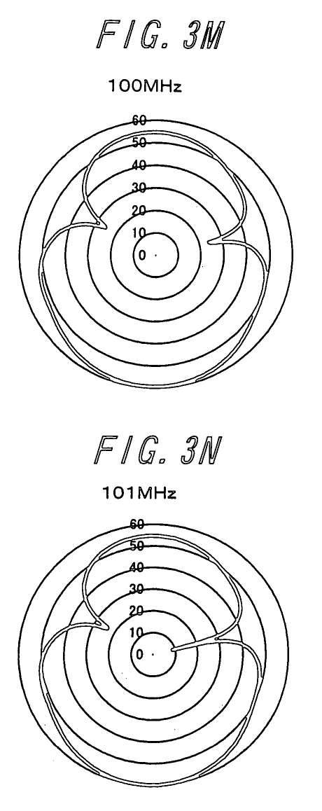

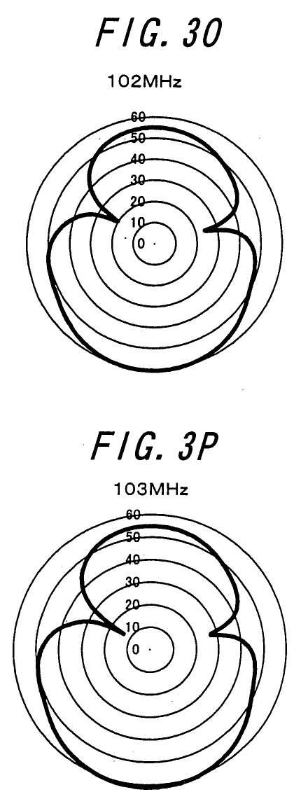

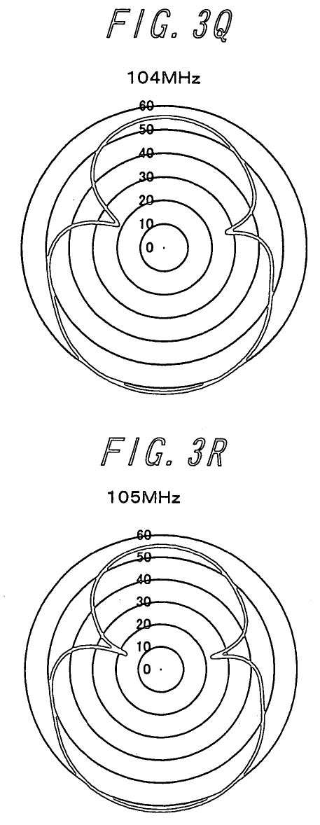

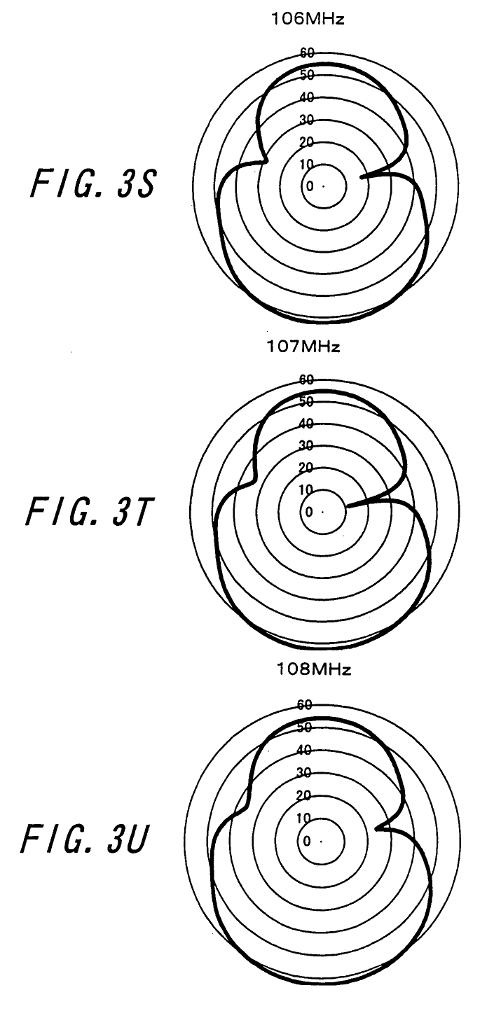

FIGS. 3A-3U shows the sensitivity and directivity measured for the glass antenna device having no inductor, respectively. Apparent from the measured results, the drop of the directivity for the glass antenna device having no inductor is observed.

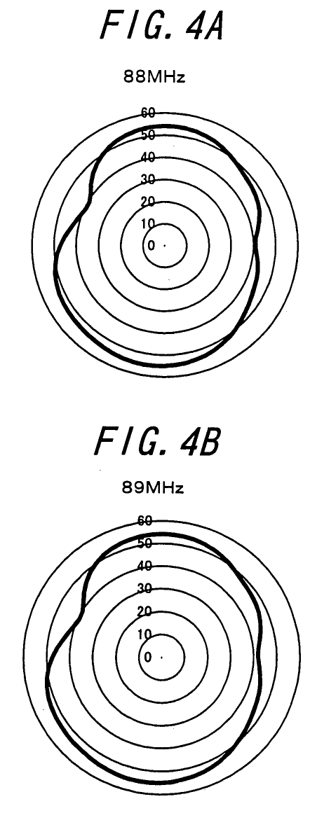

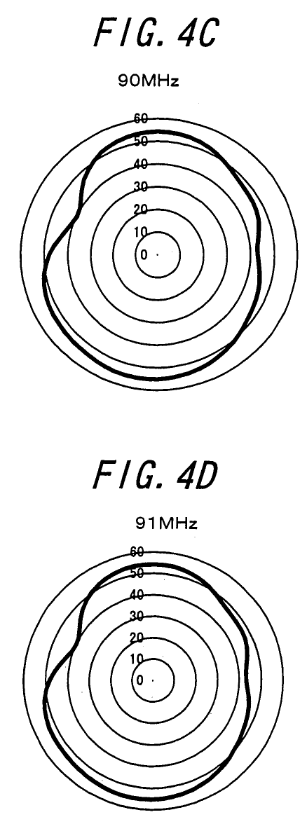

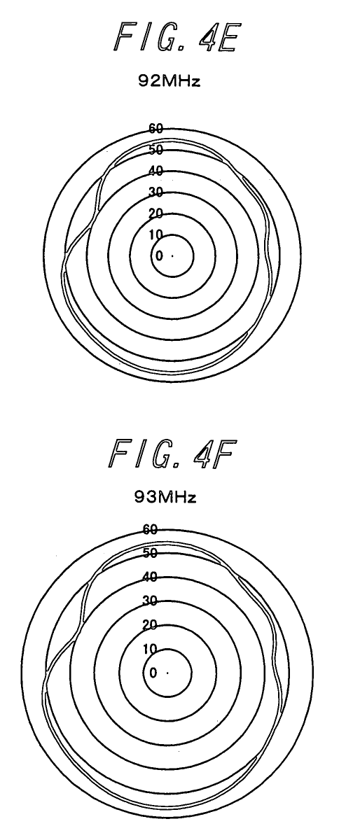

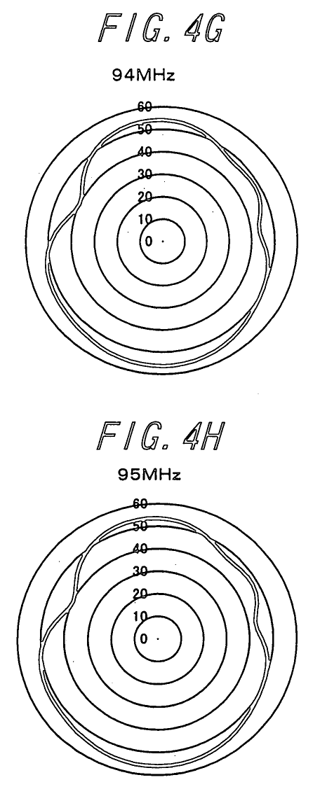

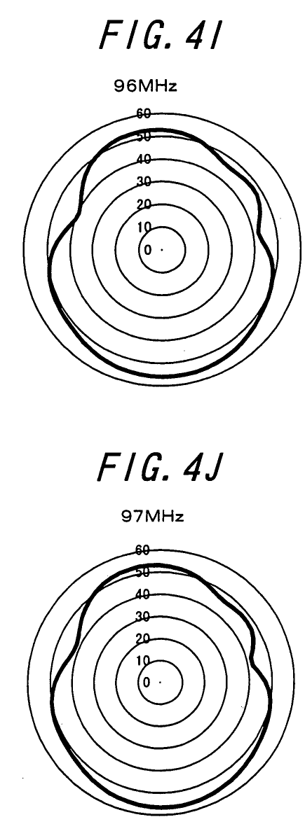

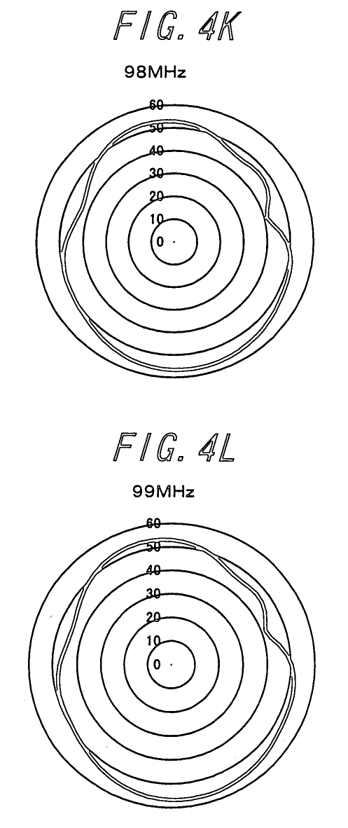

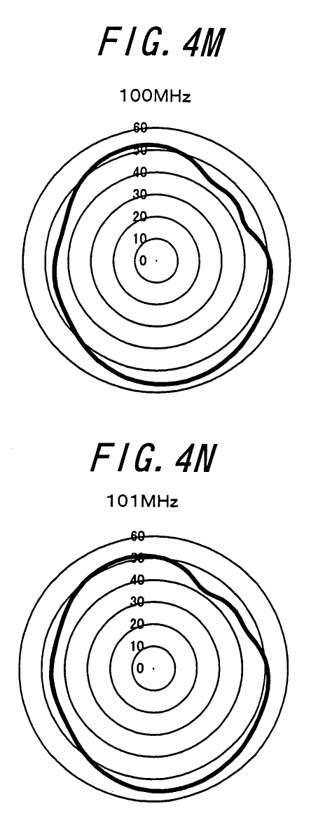

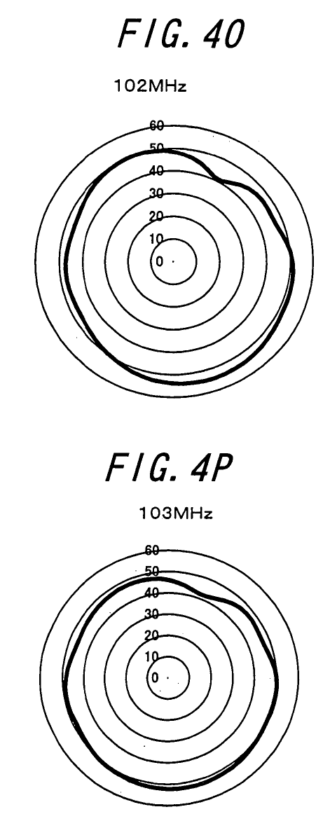

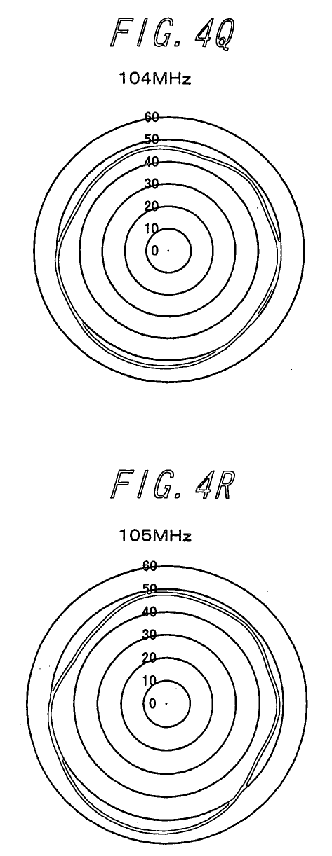

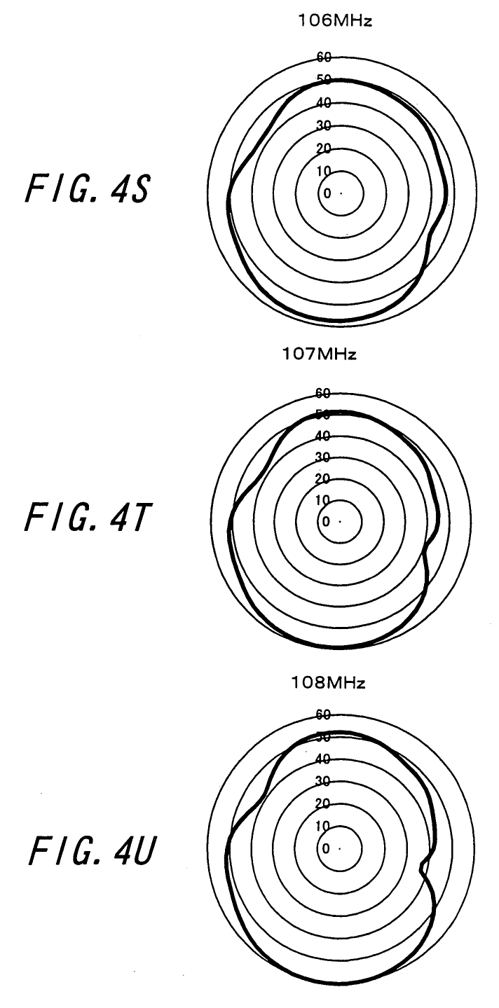

FIGS. 4A-4U show the sensitivity and directivity for the glass antenna device having the inductor 26, the inductance L thereof being 0.68 μH, respectively.

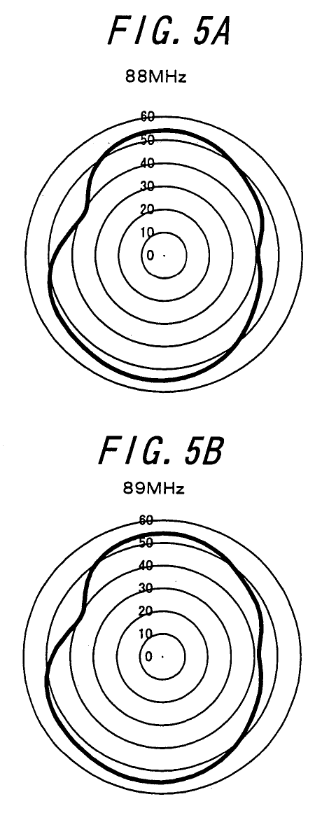

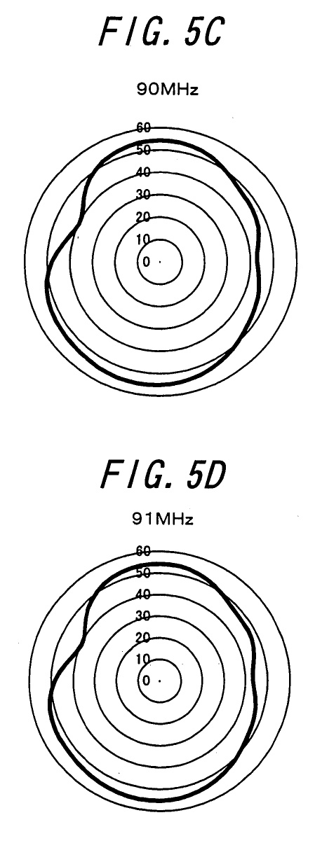

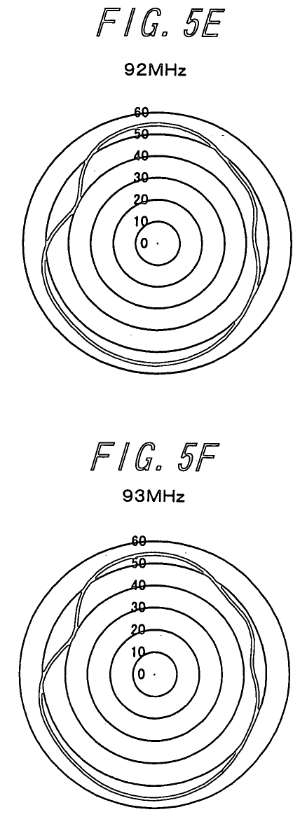

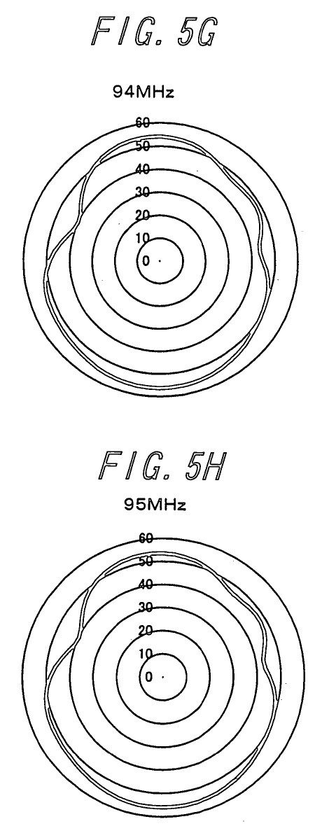

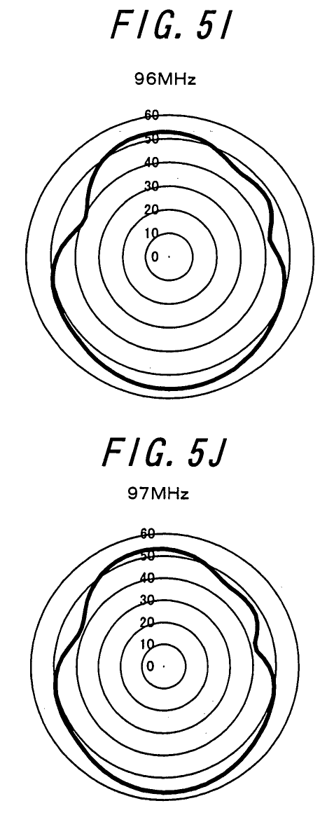

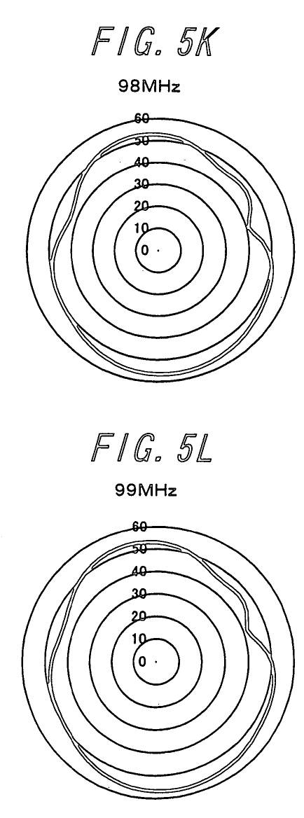

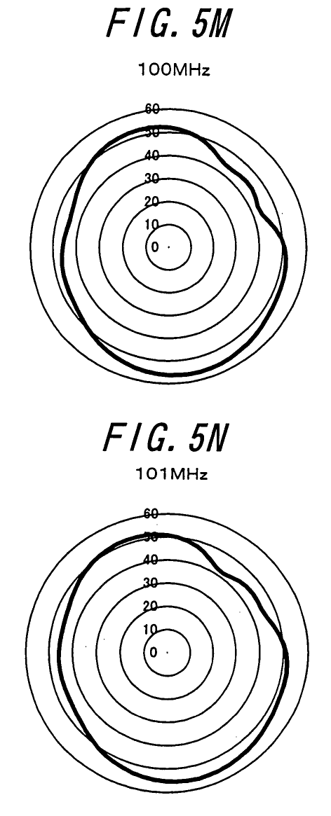

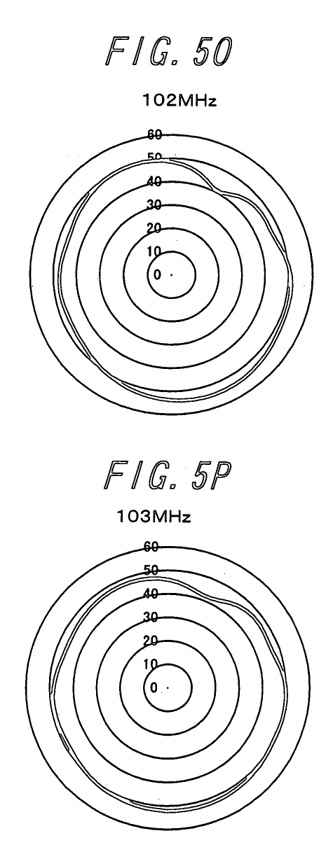

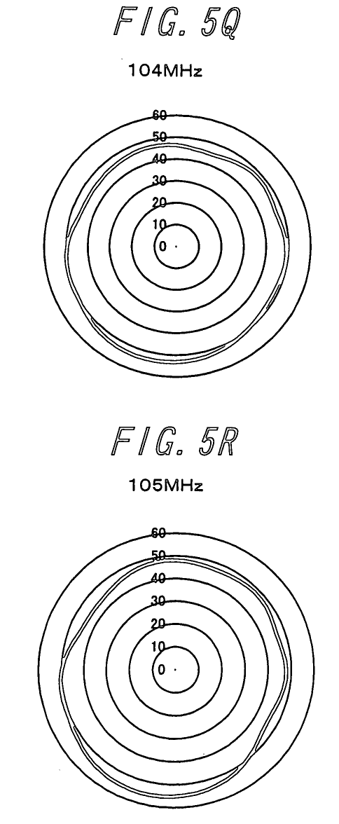

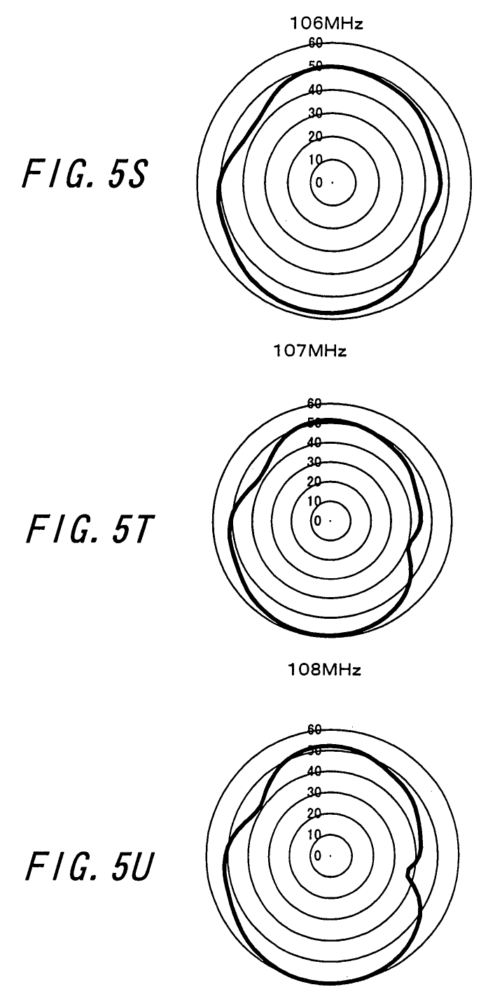

FIGS. 5A-5U show the sensitivity and directivity for the glass antenna device having the inductor 26, the inductance L thereof being 1.0 μH, respectively.

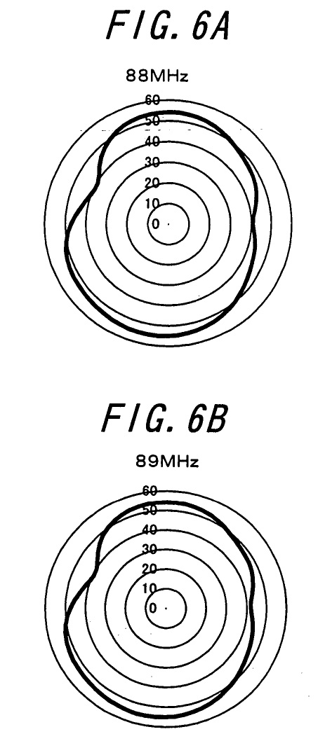

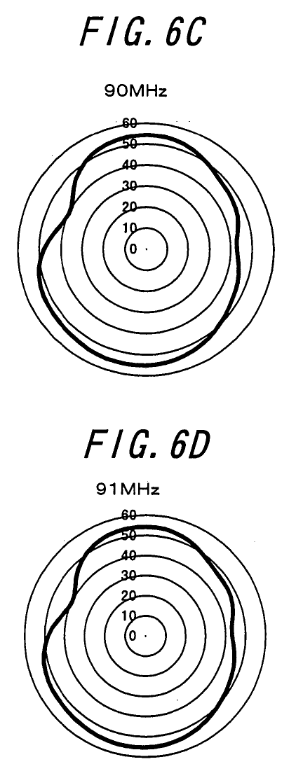

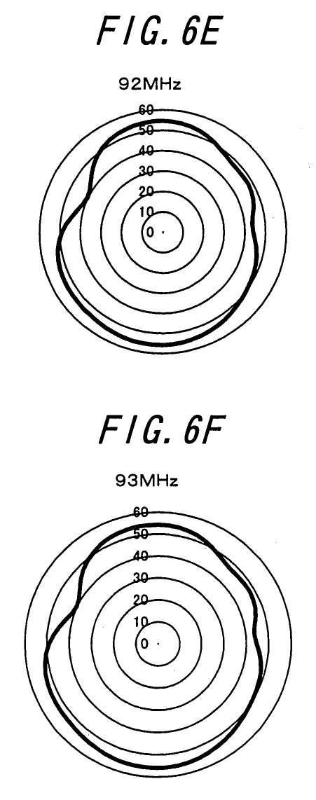

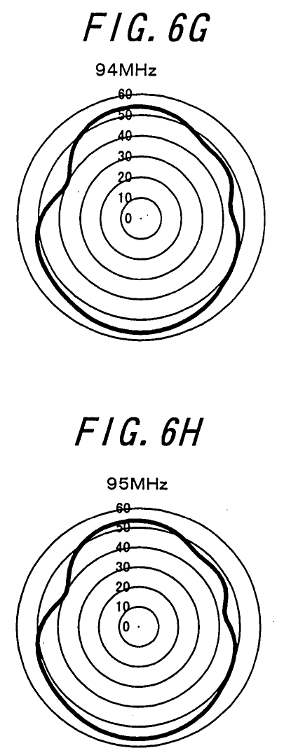

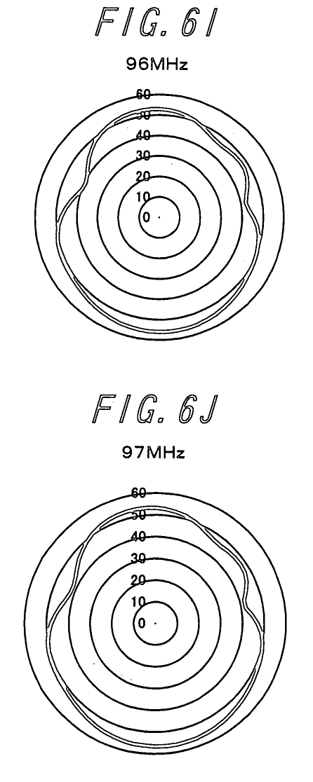

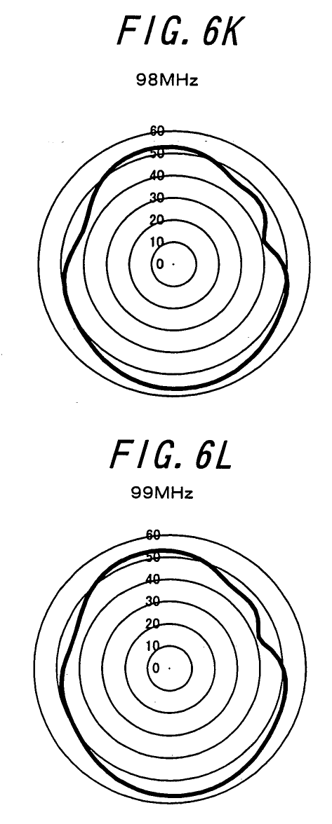

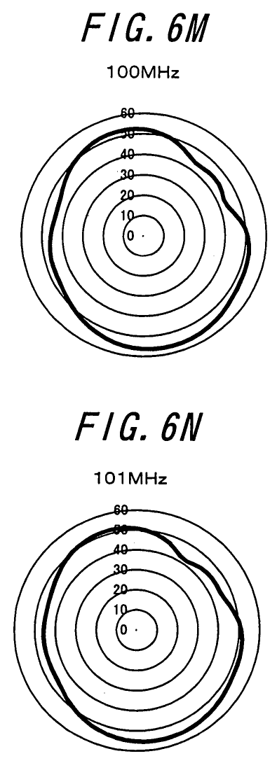

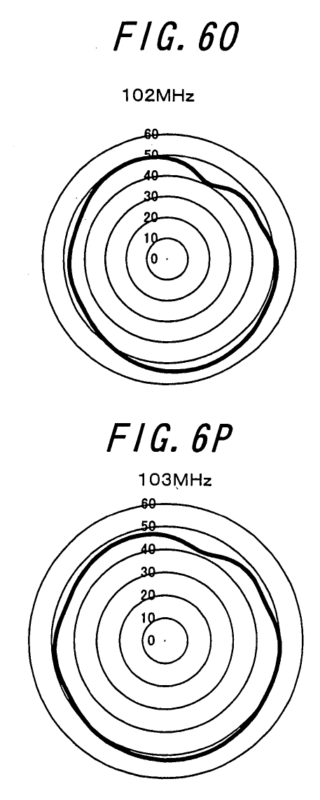

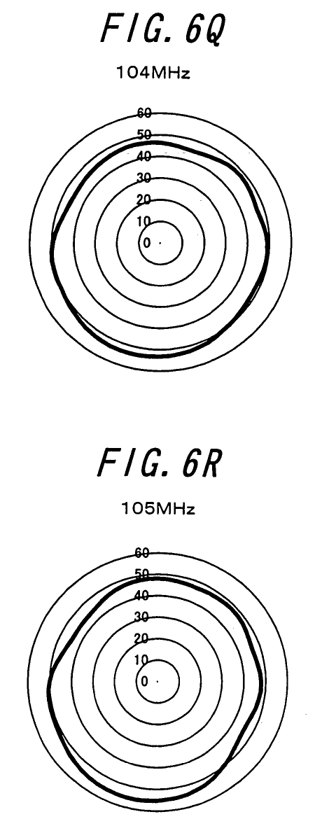

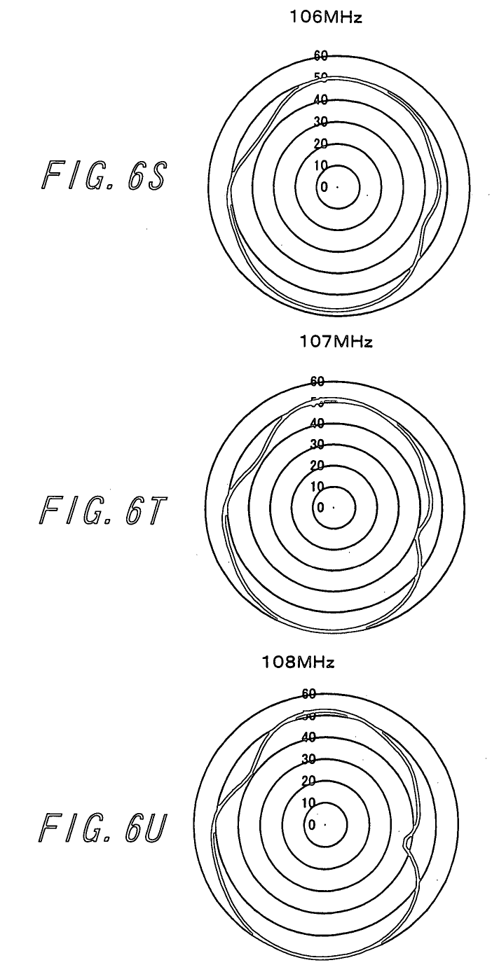

FIGS. 6A-6U show the sensitivity and directivity for the glass antenna device having the inductor 26, the inductance L thereof being 2.2 μH, respectively.

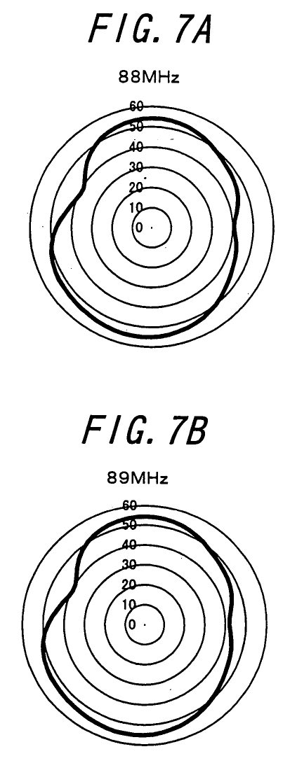

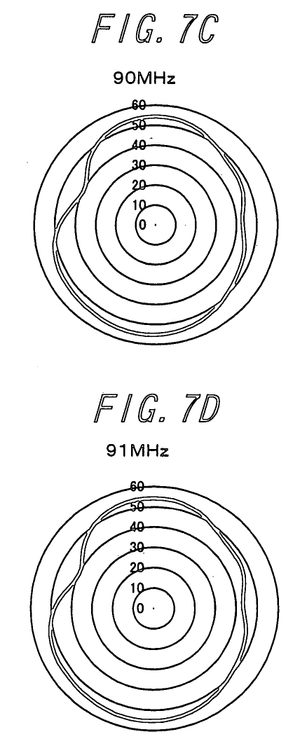

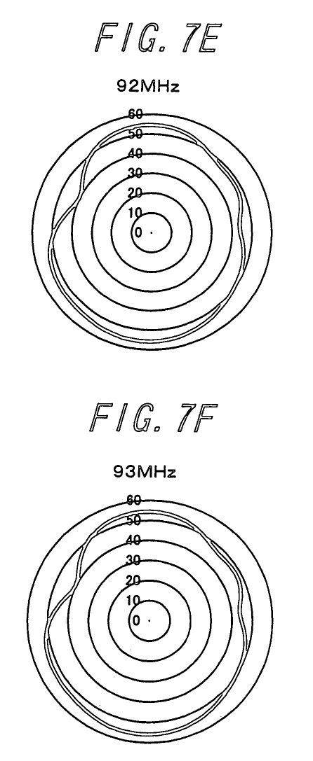

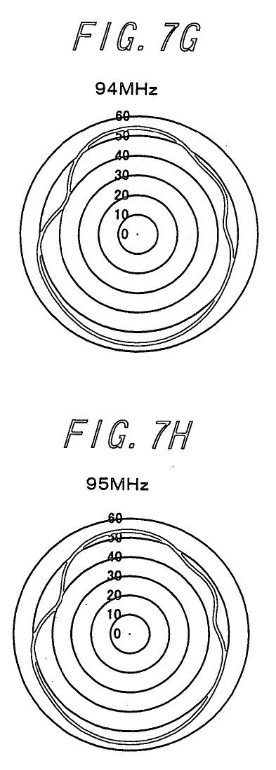

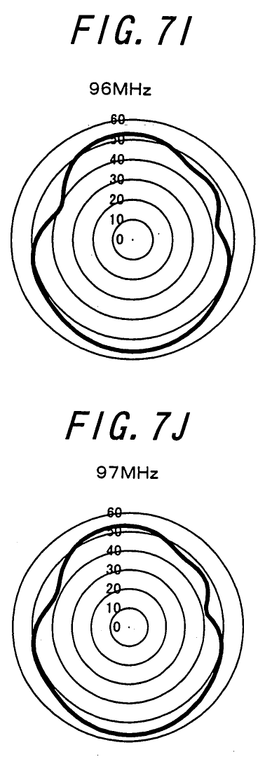

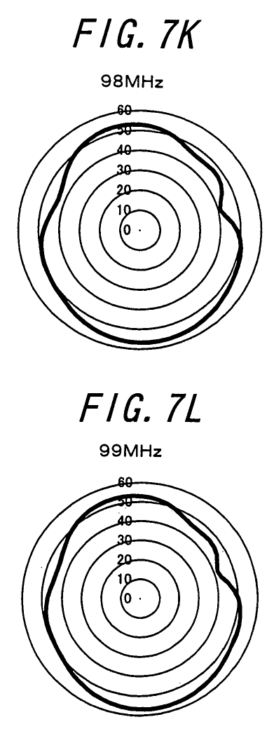

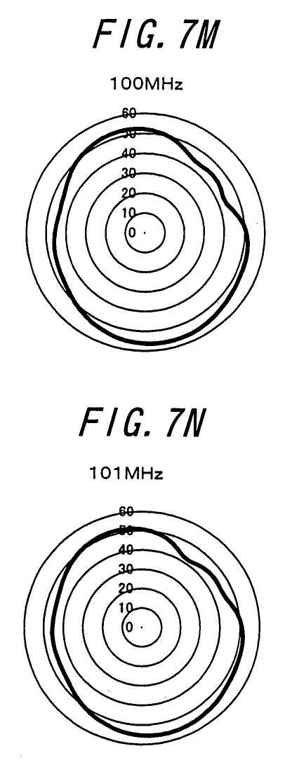

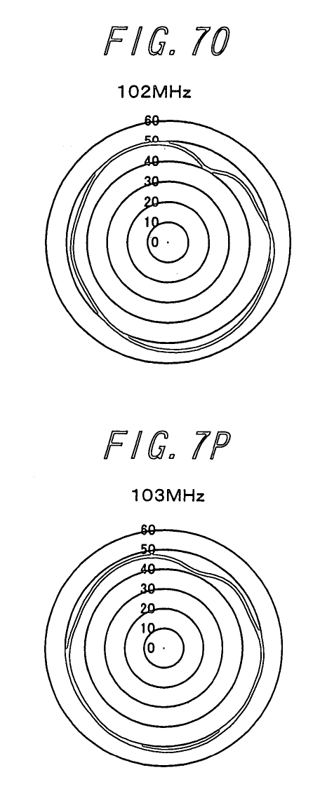

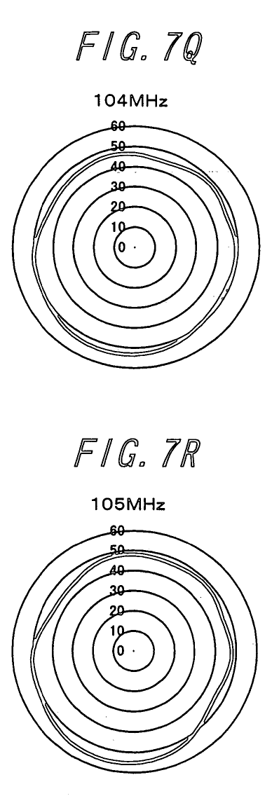

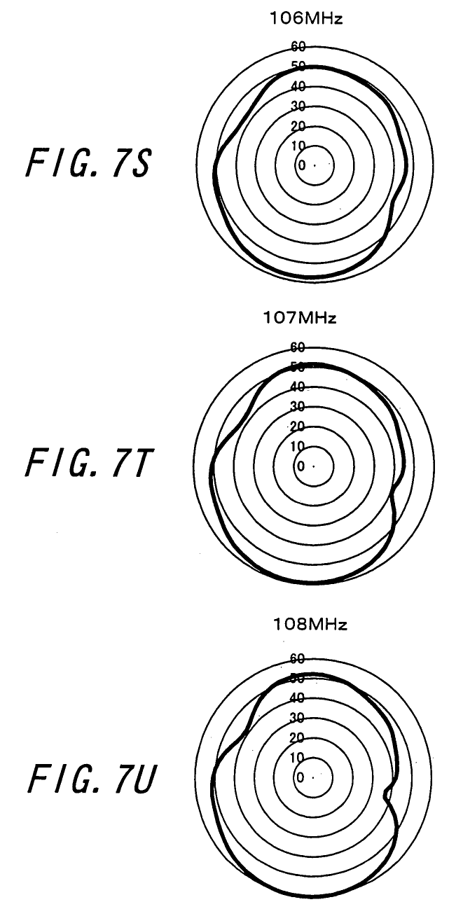

FIGS. 7A-7U show the sensitivity and directivity for the glass antenna device having the inductor 26, the inductance L thereof being 3.9 μH, respectively.

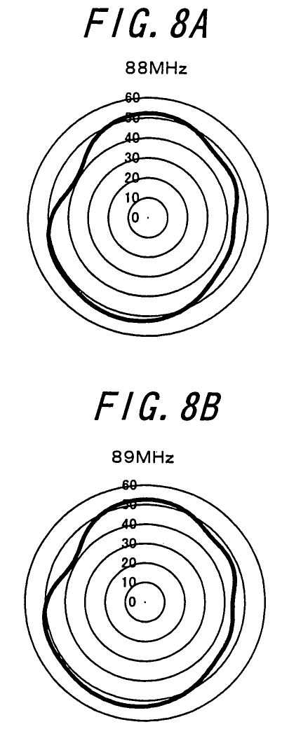

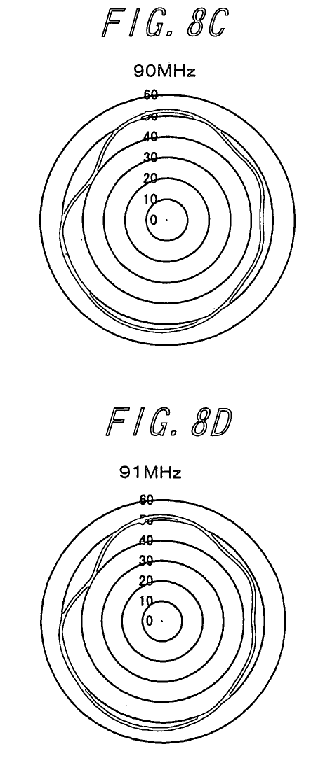

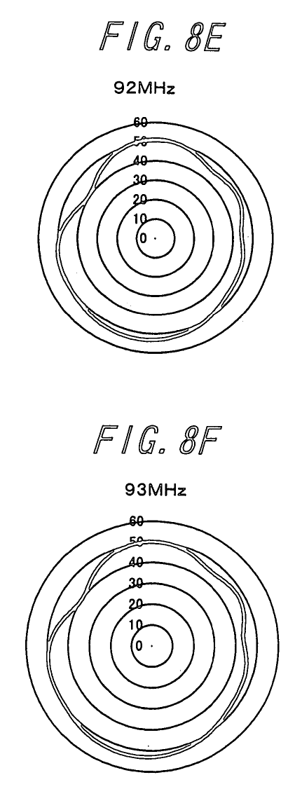

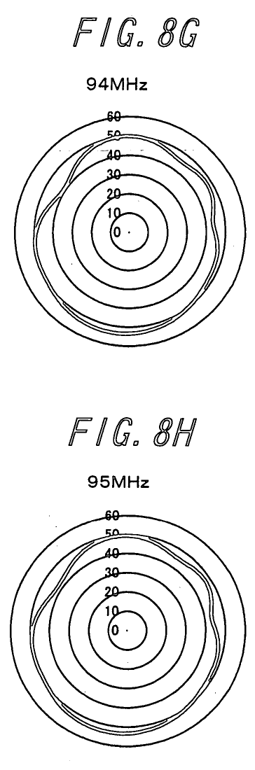

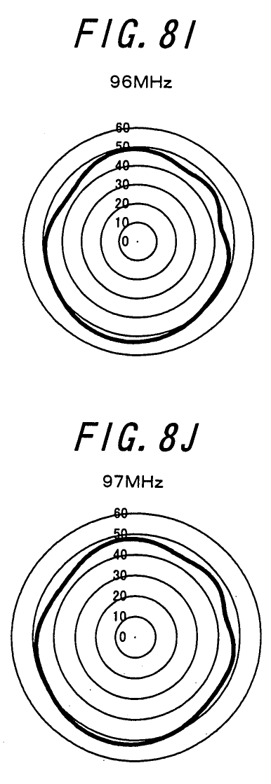

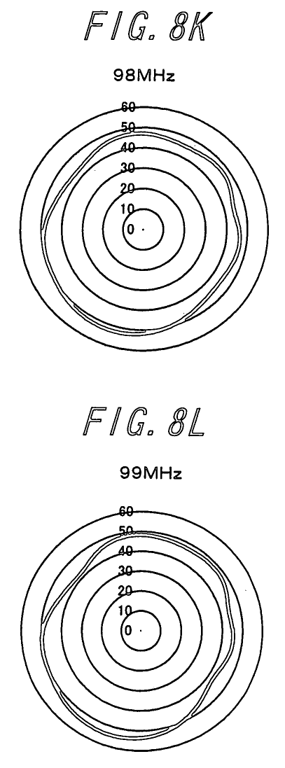

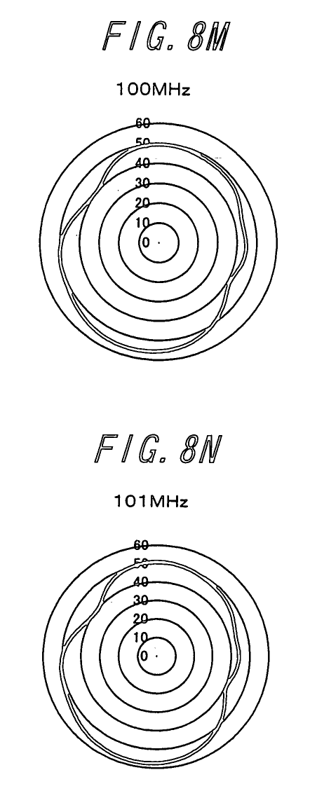

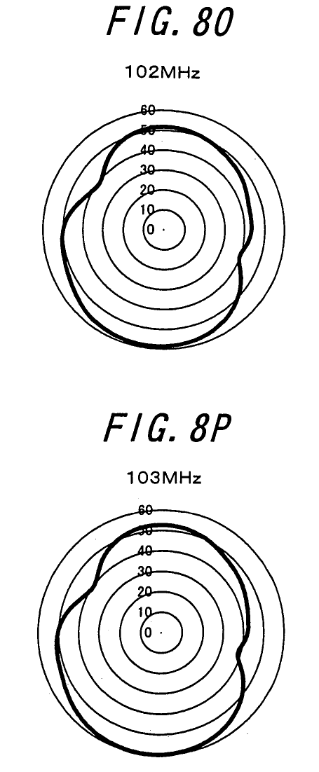

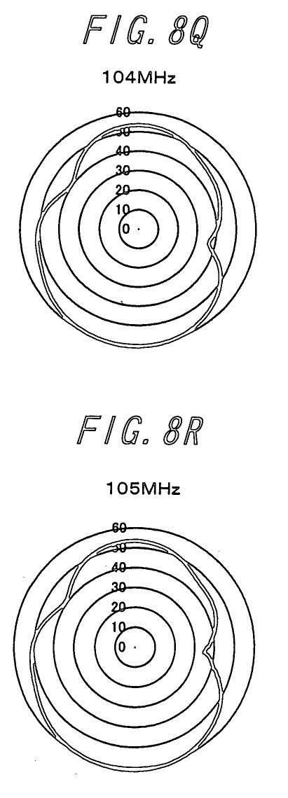

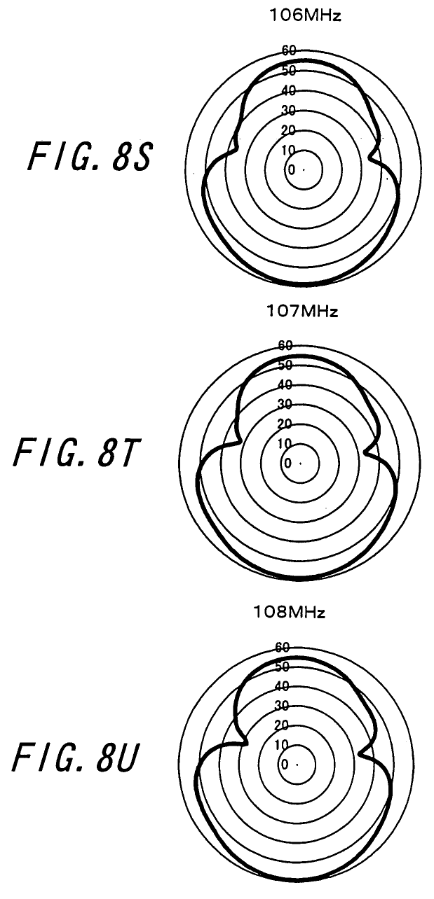

FIGS. 8A-8U show the sensitivity and directivity for the glass antenna device having the inductor 26, the inductance L thereof being 6.8 μH, respectively.

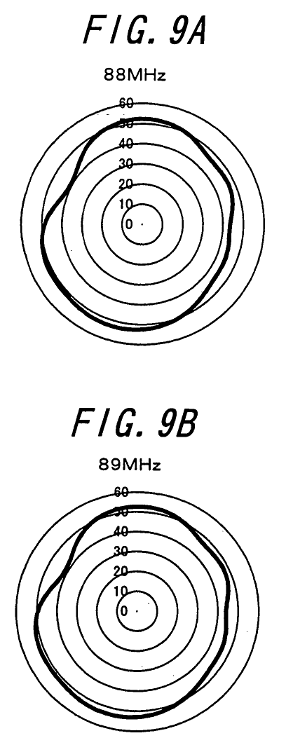

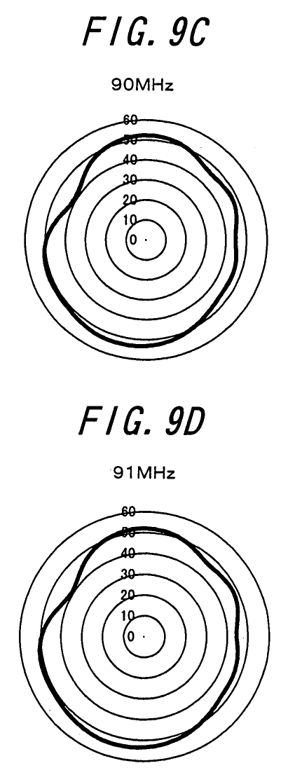

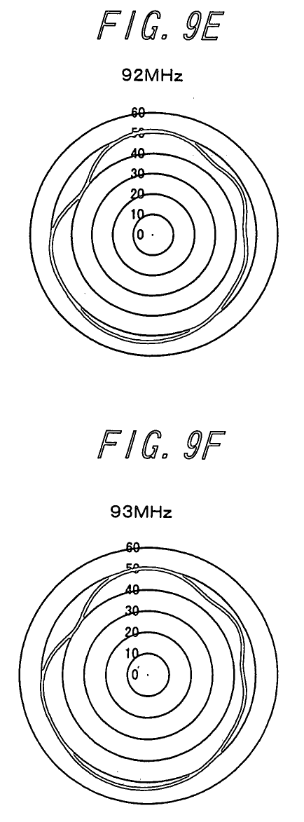

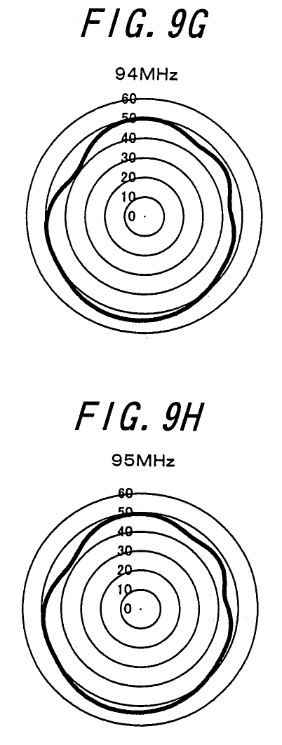

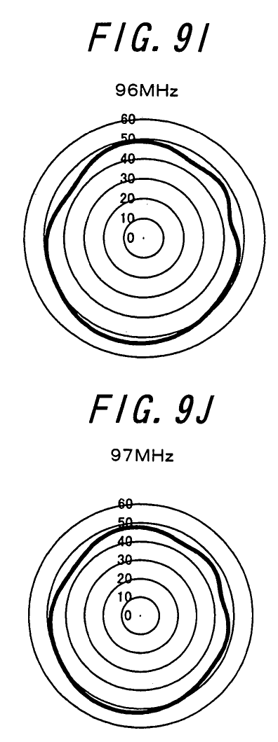

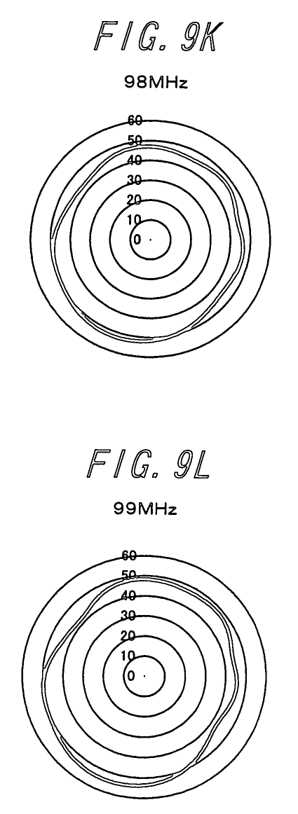

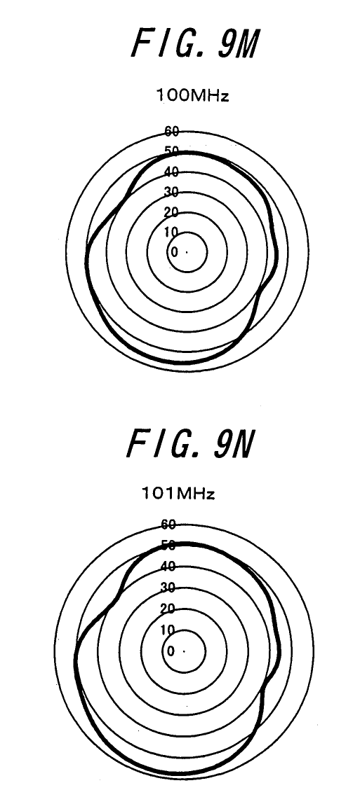

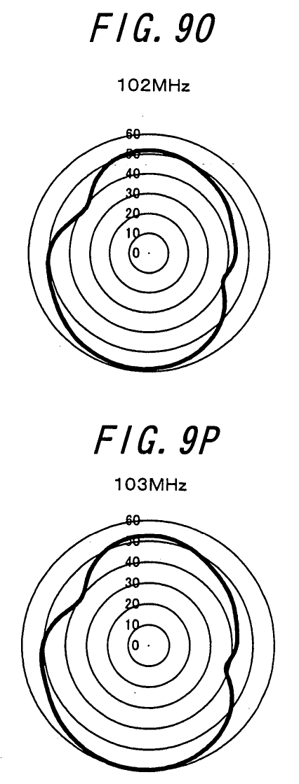

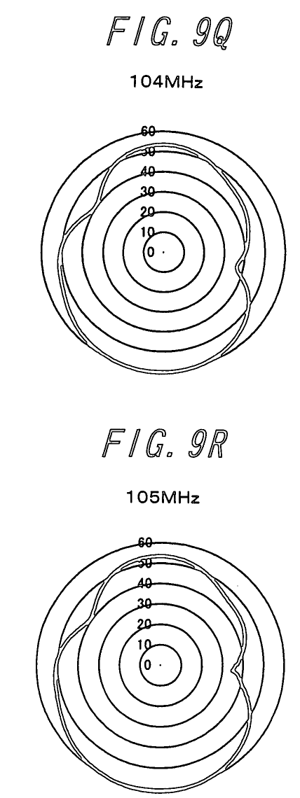

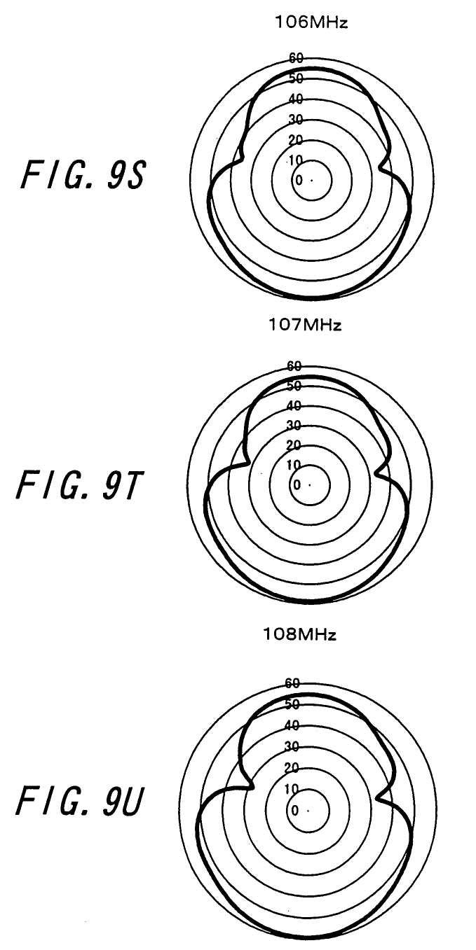

FIGS. 9A-9U show the sensitivity and directivity for the glass antenna device having the inductor 26, the inductance L thereof being 8.2 μH, respectively.

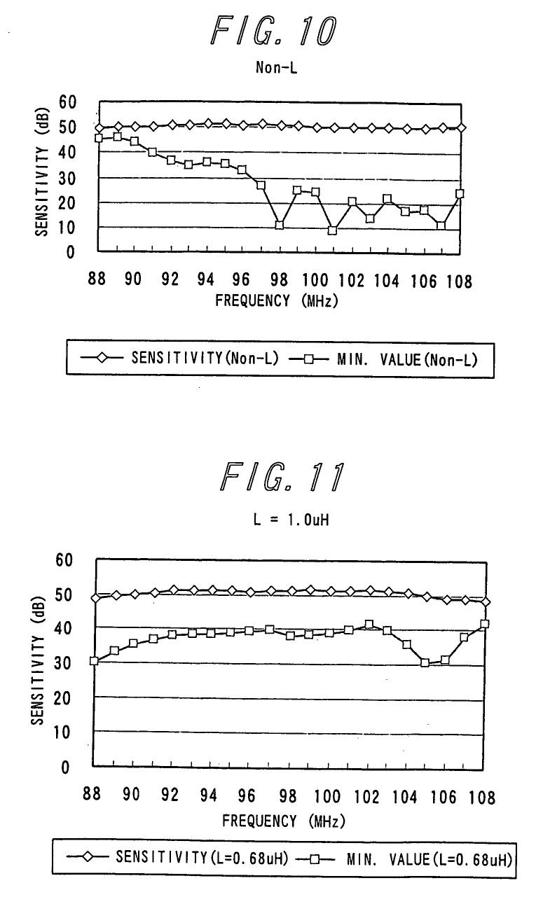

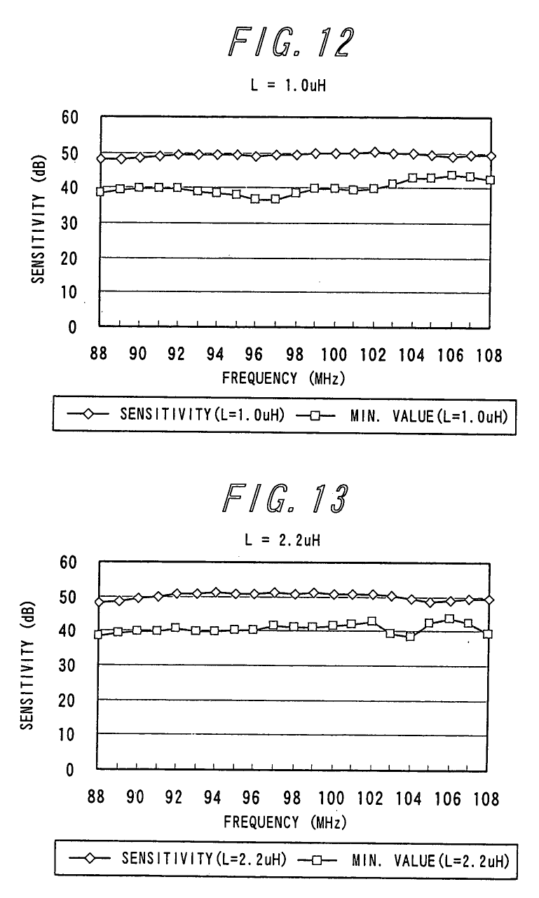

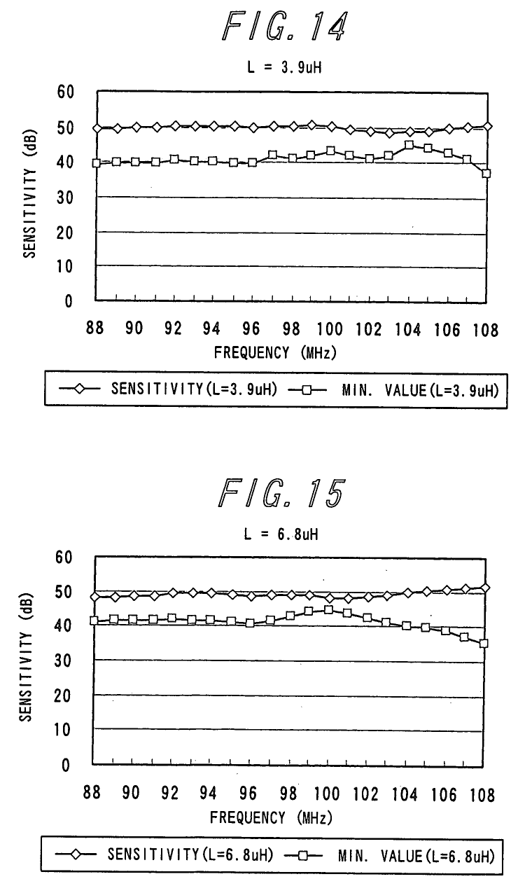

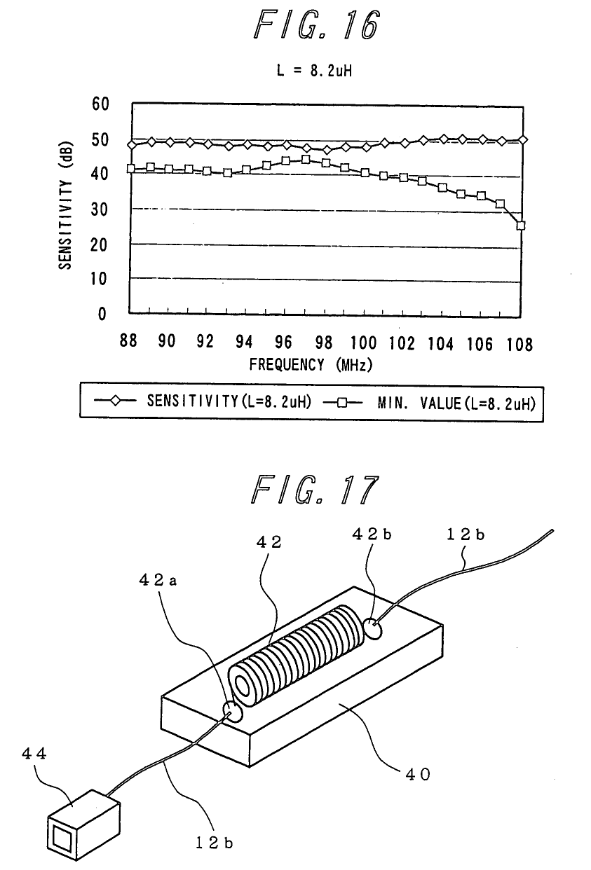

FIGS. 10-16 show the graphs illustrating the measured values. Also, the measured results are shown in TABLE 1.

Average sensitivity/Minimum data for an inductor (L)

[dB]

| | | | L = 0.68 uH | | L = 1.0 uH | | L = 2.2 uH | | L = 3.9 uH | | L = 6.8 uH | | L = 8.2 uH | |
|---|---|---|---|---|---|---|---|---|---|---|---|---|---|---|
| | Non-L | | Sensi- | Min. | Sensi- | Min. | Sensi- | Min. | Sensi- | Min. | Sensi- | Min. | Sensi- | Min. |
| | Sensi- | Min. | tivity | value | tivity | value | tivity | value | tivity | value | tivity | value | tivity | value |
| | tivity | value | (L = | (L = | (L = | (L = | (L = | (L = | (L = | (L = | (L = | (L = | (L = | (L = |
| f(MHz) | (non-L) | (non-L) | 0.68 uH) | 0.68 uH) | 1.0 uH) | 1.0 uH) | 2.2 uH) | 2.2 uH) | 3.9 uH) | 3.9 uH) | 6.8 uH) | 6.8 uH) | 8.2 uH) | 8.2 uH) |
| 88 | 49.6 | 44.9 | 48.6 | 30.1 | 47.9 | 38.5 | 48.0 | 38.5 | 49.3 | 39.4 | 47.9 | 41.2 | 48.2 | 40.9 |
| 89 | 50.1 | 45.9 | 49.3 | 33.0 | 48.3 | 39.4 | 48.7 | 39.3 | 49.6 | 39.5 | 48.2 | 41.5 | 48.8 | 41.3 |
| 90 | 50.3 | 43.7 | 49.9 | 35.1 | 48.6 | 39.7 | 49.3 | 39.8 | 49.8 | 39.8 | 48.5 | 41.4 | 48.8 | 41.0 |
| 91 | 50.1 | 39.6 | 50.3 | 36.4 | 48.8 | 39.6 | 49.8 | 39.9 | 50.0 | 39.9 | 48.7 | 41.4 | 48.9 | 40.9 |
| 92 | 50.6 | 36.2 | 51.0 | 37.9 | 49.4 | 39.5 | 50.6 | 40.4 | 50.5 | 40.4 | 49.3 | 41.8 | 48.5 | 40.7 |
| 93 | 50.6 | 34.4 | 51.1 | 38.4 | 49.4 | 39.0 | 50.8 | 39.9 | 50.5 | 40.3 | 49.3 | 41.5 | 48.1 | 40.3 |
| 94 | 51.2 | 36.0 | 51.3 | 38.4 | 49.6 | 38.6 | 51.1 | 39.8 | 50.5 | 40.1 | 49.4 | 41.4 | 48.4 | 41.1 |
| 95 | 51.1 | 35.0 | 51.0 | 38.8 | 49.2 | 37.8 | 50.9 | 40.0 | 50.2 | 39.9 | 49.0 | 41.2 | 48.3 | 42.2 |
| 96 | 50.9 | 32.6 | 50.8 | 39.2 | 48.9 | 36.7 | 50.6 | 40.3 | 49.9 | 39.5 | 48.6 | 40.8 | 48.4 | 43.7 |
| 97 | 51.1 | 26.4 | 51.2 | 39.9 | 49.3 | 36.6 | 51.0 | 41.3 | 50.4 | 41.7 | 48.9 | 41.6 | 47.8 | 43.9 |
| 98 | 50.8 | 10.7 | 51.3 | 37.8 | 49.4 | 38.3 | 50.9 | 40.9 | 50.5 | 41.1 | 48.8 | 42.7 | 47.4 | 43.2 |
| 99 | 50.9 | 24.6 | 51.6 | 38.3 | 49.9 | 39.8 | 51.1 | 41.1 | 50.6 | 41.7 | 48.9 | 44.2 | 47.9 | 42.0 |
| 100 | 50.4 | 24.2 | 51.3 | 38.9 | 49.8 | 39.6 | 50.8 | 41.6 | 50.1 | 43.2 | 48.3 | 44.4 | 48.3 | 40.6 |
| 101 | 50.1 | 8.9 | 51.3 | 39.8 | 49.8 | 39.1 | 50.7 | 41.8 | 49.5 | 41.9 | 47.9 | 43.7 | 49.2 | 39.8 |
| 102 | 50.3 | 20.3 | 51.5 | 41.4 | 50.1 | 39.8 | 50.8 | 42.7 | 49.1 | 41.0 | 48.4 | 42.5 | 49.6 | 39.4 |
| 103 | 50.0 | 13.5 | 51.1 | 39.8 | 49.9 | 41.0 | 50.2 | 39.3 | 48.5 | 42.0 | 48.8 | 41.1 | 50.2 | 38.5 |
| 104 | 50.2 | 21.9 | 50.9 | 35.7 | 49.8 | 42.8 | 49.4 | 38.6 | 48.8 | 44.8 | 49.7 | 40.3 | 50.8 | 36.7 |
| 105 | 50.2 | 17.0 | 49.9 | 30.4 | 49.2 | 42.7 | 48.7 | 42.5 | 49.1 | 44.2 | 50.1 | 39.9 | 50.9 | 34.8 |
| 106 | 50.3 | 17.2 | 49.0 | 31.4 | 49.1 | 43.7 | 48.8 | 43.8 | 49.7 | 42.8 | 50.7 | 39.0 | 50.6 | 34.5 |
| 107 | 50.6 | 11.4 | 48.8 | 37.8 | 49.5 | 43.4 | 49.3 | 42.3 | 50.5 | 40.9 | 51.3 | 37.2 | 50.4 | 32.1 |
| 108 | 50.5 | 24.3 | 48.7 | 41.8 | 49.6 | 42.4 | 49.2 | 39.2 | 50.6 | 37.0 | 51.4 | 35.3 | 50.6 | 25.9 |
| Ave. | 50.5 | 27.1 | 50.5 | 37.2 | 49.3 | 39.9 | 50.0 | 40.6 | 49.9 | 41.0 | 49.1 | 41.1 | 49.1 | 39.2 |
| Max. | 51.2 | 45.9 | 51.6 | 41.8 | 50.1 | 43.7 | 51.1 | 43.8 | 50.6 | 44.8 | 51.4 | 44.4 | 50.9 | 43.9 |
| Min. | 49.6 | 8.9 | 48.6 | 30.1 | 47.9 | 36.6 | 48.0 | 38.5 | 48.5 | 37.0 | 47.9 | 35.3 | 47.4 | 25.9 |

In FIGS. 10-16 and TABLE 1, the minimum value designates the dropped value of the directivity. It is appreciated that the inductance L of the inductor 26 is preferably in the range of 1.0-6.8 μH.

Next, the structure of the lead wire 12b will now be described. Reference to FIG. 17, there is shown the structure of the lead wire 12b in which an inductor 42 is inserted. The inductor 42 is mounted on a glass epoxy resin substrate 40 by means of soldering and is inserted in the lead wire 12b. Reference numerals 42a and 42b show the soldered parts, respectively. The end of the lead wire 12b toward the antenna is connected to a connector 44. The connector 44 is coupled to a connector (not shown) provided to the AM feeding terminal 12a. As an example, the length of the lead wire 12b from the soldered part 42a to the connector 44 is 3.5 cm, and the length of lead wire 12b from the soldered part 42b to the amplifier 22 is 19 cm. The length of the inductor 42 is 0.5 cm.

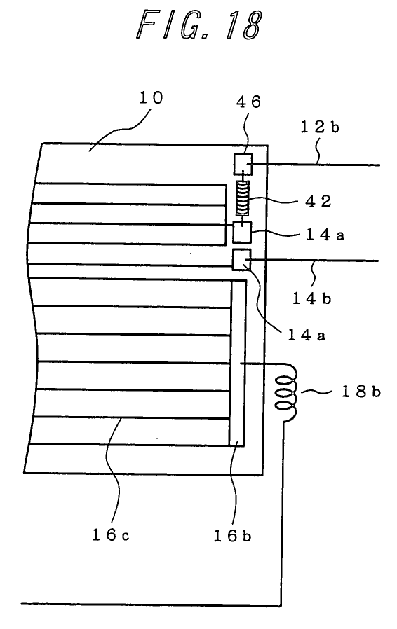

FIG. 18 shows another example of the mounting of an inductor. The inductor 42 is soldered between a terminal base 46 formed on the rear window glass panel 10 and the AM feeding terminal 14. The AM lead wire 12b is extend from the terminal base 46.

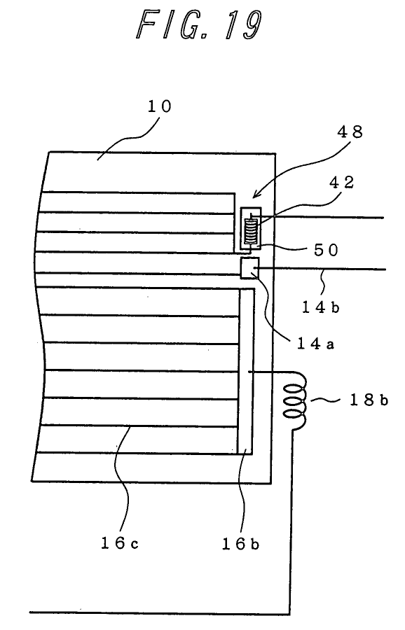

FIG. 19 shows a further example of the mounting of an inductor. A feeding terminal 48 is provided on the rear glass window panel 10. The feeding terminal 48 comprises the inductor 42 mounted on one terminal base 50.

1. An antenna device for a motor vehicle comprising:
a defogger provided on a rear window glass panel of the motor vehicle;
an AM antenna provided in a space other than the defogger on the rear window glass panel;
an FM antenna provided in a space between the defogger and the AM antenna on the rear window glass panel;
a two-input amplifier for amplifying signals received by the AM and FM antennas;
an AM lead wire for connecting between a feeding terminal of the AM antenna and the amplifier;
an FM lead wire for connecting between a feeding terminal of the FM antenna and the amplifier; and
an inductor inserted in the AM lead wire near to the AM feeding terminal;
wherein the inductor opens the AM lead wire in a high frequency to cut off a signal from the AM antenna when a signal received by the FM antenna is amplified by the amplifier.

2. An antenna device for a motor vehicle comprising:
a defogger provided on a rear window glass panel of the motor vehicle;
an AM antenna provided in a space other the defogger on the rear window glass panel;
an FM antenna provided in a space between the defogger and the AM antenna on the rear window glass panel;
a two-input amplifier for amplifying signals received by the AM and FM antennas;
a terminal base provided near to the feeding terminal of the AM antenna on the rear window glass panel;
an inductor provided between the feeding terminal of the AM antenna and the terminal base;
an AM lead wire for connecting between the terminal base and the amplifier; and
an FM lead wire for connecting between a feeding terminal of the FM antenna and the amplifier;
wherein the inductor opens the AM lead wire in a high frequency to cut off a signal from the AM antenna when a signal received by the FM antenna is amplified by the amplifier.

3. An antenna device for a motor vehicle comprising:
a defogger provided on a rear window glass panel of the motor vehicle;
an AM antenna provided in a space other than the defogger on the rear window glass panel;
an FM antenna provided in a space between the defogger and the AM antenna on the rear glass window panel;
a two-input amplifier for amplifying signals received by the AM and FM antennas;
a feeding terminal of the AM antenna provided with an inductor;
an AM lead wire for connecting between a feeding terminal of the AM antenna and the amplifier; and
an FM lead wire for connecting between a feeding terminal of the FM antenna and the amplifier;
wherein the inductor opens the AM lead wire in a high frequency to cut off a signal from the AM antenna when a signal received by the FM antenna is amplified by the amplifier.

4. The glass antenna device according to claim 1, 2 or 3, wherein the inductance of the inductor is in the range of 1.0 μH -6.8 μH.
